(19) United States
(12) Patent Application Publication
(10) Pub. No.: US 2013/0169959 A1
(43) Pub. Date: Jul. 4, 2013

(54) ZERO ORDER SENSING TO INCREASE LIGHT COLLECTION IN A SPECTROMETER

(71) Applicant: Brett Guenther, Cary (NC)

(72) Inventor: Brett Guenther, Cary (NC)

(73) Assignee: Optopo Inc. d/b/a Centice Corp.

(21) Appl. No.: 13/544,918

(22) Filed: Jul. 9, 2012

Related U.S. Application Data
(60) Provisional application No. 61/506,009, filed on Jul. 8, 2011.

(51) Int. Cl. G01J 3/02; G01J 3/44

(52) U.S. Cl. CPC G01J 3/0237; G01J 3/4412
USPC 356/301; 356/326

(57) ABSTRACT

A system for increasing light collection in a spectrometer includes a detector and a processor. The detector detects zero order diffraction light from a diffractive element of a spectrometer and measures an intensity of the zero order diffraction light. A processor continuously receives the intensity measurement from the detector and automatically adjusts a parameter of the spectrometer until a maximum intensity measurement is received from the detector. A parameter of the spectrometer can include an optical path between an aperture of the spectrometer and a sample, an exposure time of the spectrometer, or an intensity of a light source for the spectrometer. The optical path between an aperture of the spectrometer and a sample can be adjusted by moving an objective lens of the spectrometer with respect to the sample or moving the sample with respect to the spectrometer.

### CROSS-REFERENCE TO RELATED APPLICATION

This application claims the benefit of U.S. Provisional Patent Application No. 61/506,009 filed Jul. 8, 2011, which is incorporated by reference in its entirety.

### INTRODUCTION

Typically, spectrometers measure a sample at a fixed distance. The spectrometer is focused at a fixed distance, and the sample is placed at that distance for the measurement. If different samples are measured that are made up of elements that vary in size, shape, or number, it may be difficult to place each of the different samples at the same fixed distance for spectroscopic measurement.

For example, a spectrometer can be used to verify the chemical signature of a dispensed pharmaceutical. A dispensed pharmaceutical can include, but is not limited to, different strengths and forms of a liquid, powder, or solid. A pharmaceutical solid is, for example, a pill. A pill can include, but is not limited to, a tablet, a caplet, a suppository, a gelcap, or a capsule. If a spectrometer is used to image pills through the open top of the prescription vial, the distance between the spectrometer and the pills is dependent on the size, shape, and number of the pills in the prescription vial. If the prescription vial is filled with a large number of pills, the distance between the spectrometer and the pills is shortened, for example. If the prescription vial contains only a few pills at the bottom of the prescription vial, the distance between the spectrometer and the pills is lengthened, for example.

More generally, the inability to place different samples made up of elements that vary in size, shape, or number at the same fixed distance for spectroscopic measurement results in a light collection problem for the spectrometer. Elements of the sample that are not in focus do not optimally scatter light into the aperture of the spectrometer. As a result, the number of photons received by the spectrometer is reduced. The reduction in the number of photons received, in turn, can decrease the signal-to-noise ratio of the measurement.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is a schematic diagram showing an optical path between a spectrometer and a dispensed pharmaceutical in a prescription vial where the prescription vial is full, in accordance with various embodiments.

FIG. 3 is a schematic diagram showing an optical path between a spectrometer and a dispensed pharmaceutical in a prescription vial where the prescription vial is not full, in accordance with various embodiments.

FIG. 4 is a diagram of the optical path of a spectrometer, in accordance with various embodiments.

FIG. 5 is a diagram of the optical path of a spectrometer that includes a lengthened collimated space in comparison to the collimated space of FIG. 4, in accordance with various embodiments.

FIG. 6 is a diagram of the optical path of a spectrometer that includes a shortened collimated space in comparison to the collimated space of FIG. 4, in accordance with various embodiments.

FIG. 7 is a schematic diagram of a system for auto-focusing a spectrometer, in accordance with various embodiments.

FIG. 8 is schematic diagram of a close-up view of a sample end of a system for auto-focusing a spectrometer, in accordance with various embodiments.

FIG. 9 is an exemplary image from a zero order detector of a system for auto-focusing a spectrometer that shows that a sample is too far away from auto-focusing system, in accordance with various embodiments.

FIG. 10 is an exemplary image from a zero order detector of a system for auto-focusing a spectrometer that shows that a sample is at the auto-focus position, in accordance with various embodiments.

FIG. 11 is an exemplary image from a zero order detector of a system for auto-focusing a spectrometer that shows that a sample is too close to the auto-focusing system, in accordance with various embodiments.

FIG. 12 is an exemplary graph showing Raman signals for a dispensed pharmaceutical located at different distances and measured using a spectrometer that includes a system for auto-focusing the spectrometer, in accordance with various embodiments.

FIG. 13 is an exemplary flowchart showing a method for auto-focusing a spectrometer, in accordance with various embodiments.

FIG. 14 is a schematic diagram of a system that includes one or more distinct software modules that perform a method for auto-focusing a spectrometer, in accordance with various embodiments.

FIG. 15 is an exemplary flowchart showing a method for increasing light collection in a spectrometer, in accordance with various embodiments.

FIG. 16 is a schematic diagram of a system that includes one or more distinct software modules that perform a method for increasing light collection in a spectrometer, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

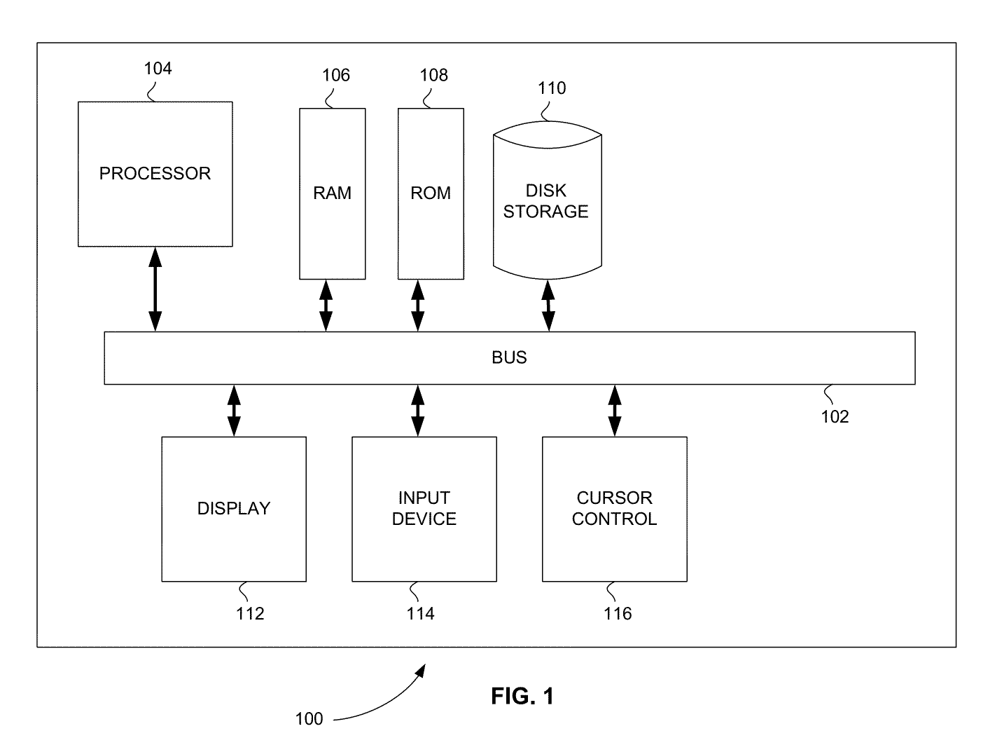

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for determining base calls, and instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Systems and Methods for Auto Focusing

As described above, spectrometers generally measure a sample at a fixed distance. If different samples are made up of elements that vary in size, shape, or number, it may be difficult to place each of the different samples at the same fixed distance for spectroscopic measurement.

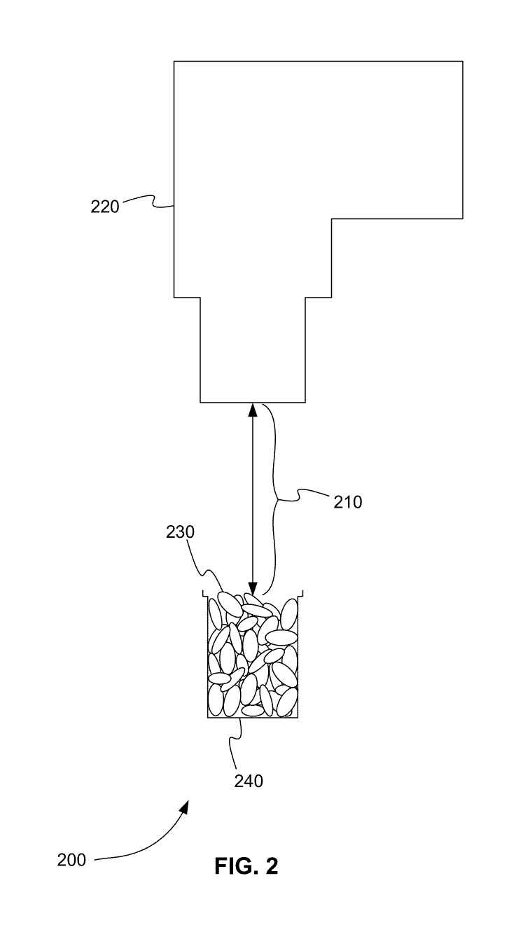

FIG. 2 is a schematic diagram showing an optical path 210 between a spectrometer 220 and a dispensed pharmaceutical 230 in a prescription vial 240 where prescription vial 240 is full, in accordance with various embodiments.

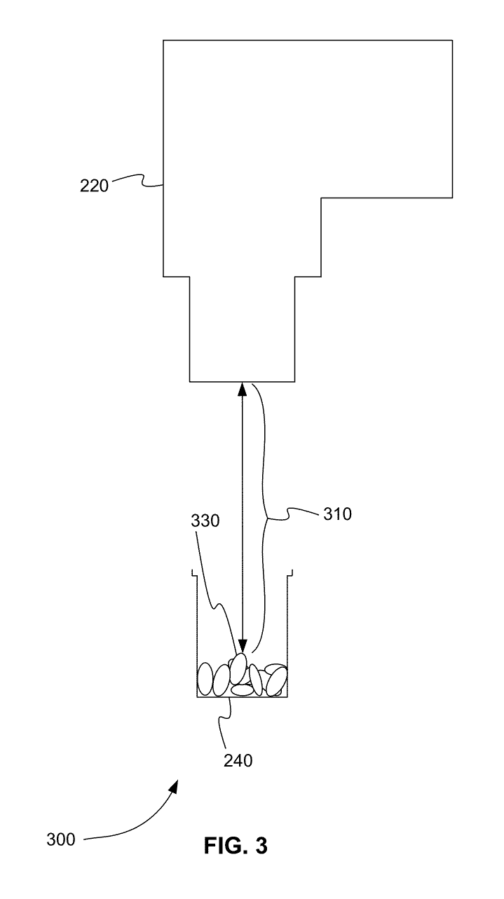

FIG. 3 is a schematic diagram showing an optical path 310 between a spectrometer 220 and a dispensed pharmaceutical 330 in a prescription vial 240 where prescription vial 240 is not full, in accordance with various embodiments. Optical path 310 is longer than optical path 210 of FIG. 2.

In various embodiments, an auto-focus system is added to a spectrometer. This auto-focus system enables the spectrometer to measure different samples at the same optical efficiency even if the distance between the spectrometer and the elements of the different samples varies.

In various embodiments, an auto-focus system of a spectrometer adjusts the collimated space of the optical path of the spectrometer. This adjustment to the collimated space does not affect imaging or losses unless the collimated space is made to be significantly large.

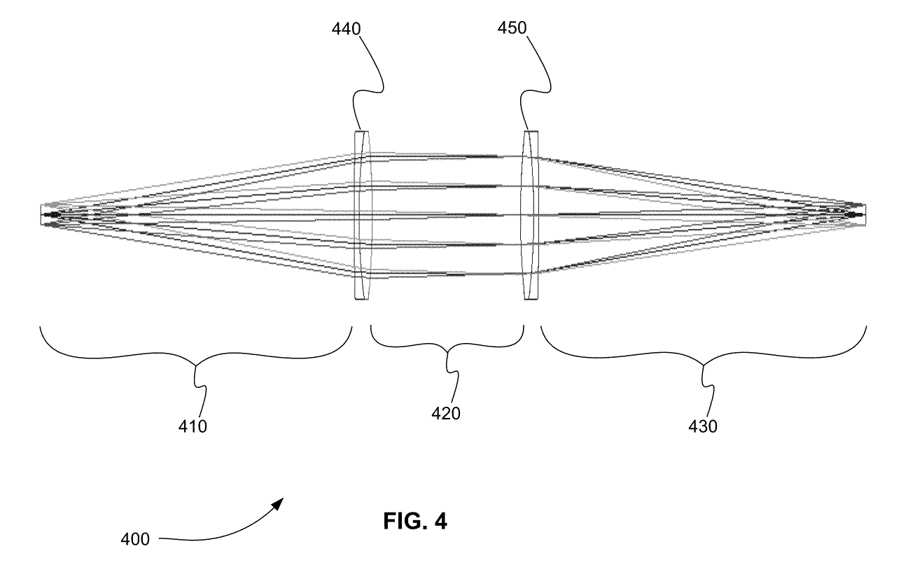

FIG. 4 is a diagram of the optical path 400 of a spectrometer, in accordance with various embodiments. Optical path 400 includes front focal length 410, collimated space 420, and back focal length 430. Collimated space 420 is created between front lens set 440 and back lens set 450. In order to change the optical path between a spectrometer and an element of a sample without changing front focal length 410 and back focal length 430, collimated space 420 is adjusted. Collimated space 420 is adjusted by moving front lens set 440 with respect to back lens set 450, for example. Moving front lens set 440 with respect to back lens set 450 can include holding back lens set 450 fixed and moving front lens set 440. Moving front lens set 440 with respect to back lens set 450 can also include holding front lens set 440 fixed and moving back lens set 450. Additionally, moving front lens set 440 with respect to back lens set 450 can include moving both back lens set 450 and front lens set 440.

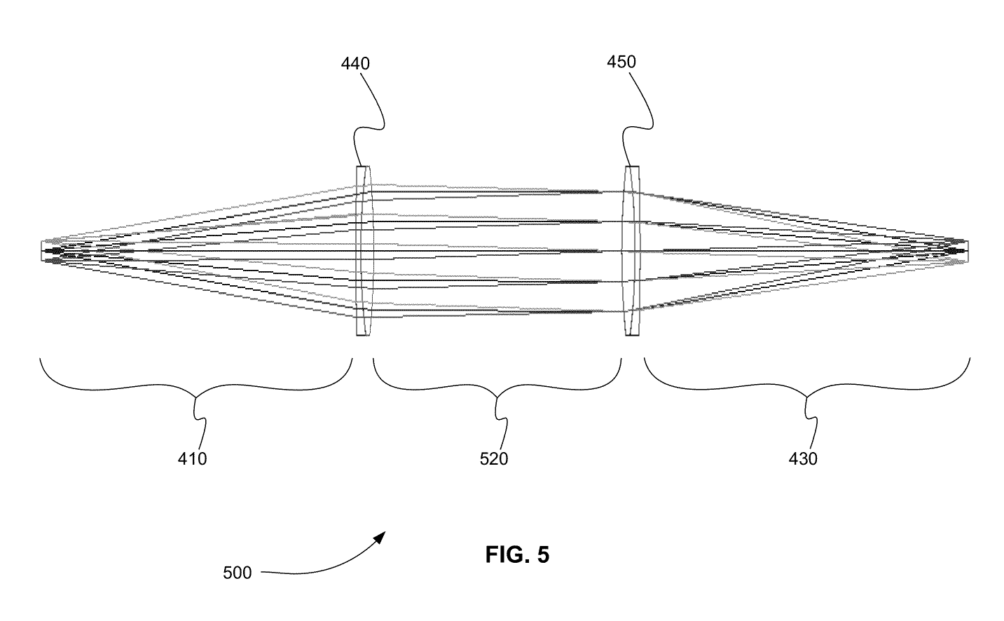

FIG. 5 is a diagram of the optical path 500 of a spectrometer that includes a lengthened collimated space 520 in comparison to the collimated space 420 of FIG. 4, in accordance with various embodiments. Collimated space 520 in FIG. 5 is lengthened by moving front lens set 440 with respect to back lens set 450.

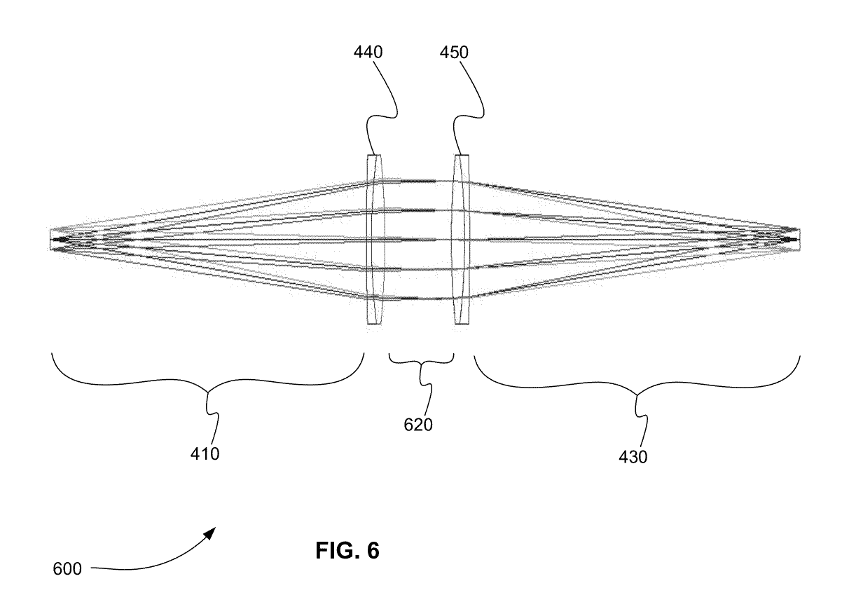

FIG. 6 is a diagram of the optical path 600 of a spectrometer that includes a shortened collimated space 620 in comparison to the collimated space 420 of FIG. 4, in accordance with various embodiments. Collimated space 620 in FIG. 6 is shortened by moving front lens set 440 with respect to back lens set 450.

In various embodiments, an auto-focus system of a spectrometer further includes a detector to determine if a sample is properly focused. The detector continuously images the input aperture of the spectrometer as the collimated space of the spectrometer is adjusted. The detector receives the light that is directly transmitted by the spectrometer or the zero order diffraction. The detector makes intensity measurements from the zero order diffraction. The collimated space of the spectrometer is adjusted in a feedback loop until the detector receives the maximum intensity of the zero order diffraction.

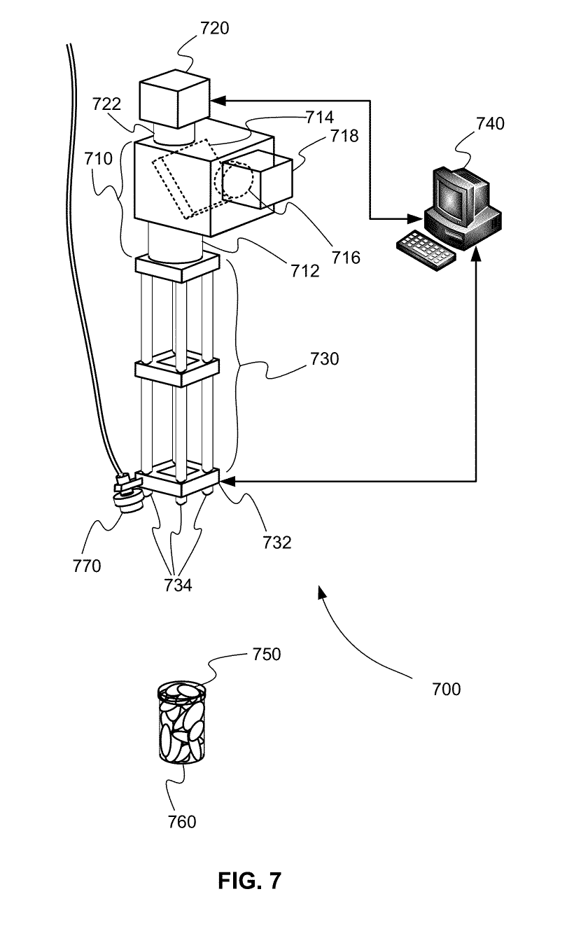

FIG. 7 is a schematic diagram of a system 700 for auto-focusing a spectrometer 710, in accordance with various embodiments. Spectrometer 710, for example, includes input aperture 712, diffractive element 714, back lens set 716, and spectrometer detector 718. Input aperture 712 can include, for example, an aperture mask, slit, or pinhole. Spectrometer detector 718 is, for example, a charged coupled device (CCD) camera. Input aperture 712 receives collimated light through input aperture 712. The collimated light is dispersed through input aperture 712 and diffractive element 714. Diffractive element 714 can be a transmissive or reflective element. Diffractive element 714 diffracts the collimated light at an angle, for example. Back lens set 716 focuses the light dispersed by input aperture 712 and diffractive element 714 on spectrometer detector 718. The light incident on spectrometer detector 718 is the first order diffraction, for example. Spectrometer 710 is a Raman spectrometer or an aperture mask spectrometer, for example.

System 700 includes a zero order detector 720, an electro-mechanical front lens set 730, and a processor 740. Zero order detector 720 is also, for example, a CCD camera. Zero order detector 720 can also be a point detector or diode, for example. Zero order detector 720 receives the zero order diffraction light from diffractive element 714 of spectrometer 710 and measures an intensity of the zero order diffraction light. Zero order detector 720 receives the zero order diffraction light through detector aperture 722. Zero order detector 720 images input aperture 712 of spectrometer 710 through detector aperture 722 and diffractive element 714.

Electro-mechanical front lens set 730 moves with respect to back lens set 716 in order to adjust a collimated space between electro-mechanical front lens set 730 and back lens set 716. Electro-mechanical front lens set 730 includes, for example, adjustable lens 732 that moves along guide rails 734. Electro-mechanical front lens set is, for example, the front end lens relay.

Processor 740 can be, but is not limited to, a computer, microprocessor, microcontroller, or any device capable of processing data and sending and receiving control signals and data. Processor 740 is, for example, a computer system as shown in FIG. 1. Processor 740 can also be a processor of spectrometer 710.

Processor 740 is in communication with zero order detector 720 and electro-mechanical front lens set 730. Processor 740 continuously receives intensity measurements from zero order detector 720 and instructs electro-mechanical front lens set 730 to continuously adjust the collimated space until the maximum intensity is received from zero order detector 720. When the maximum intensity is received from zero order detector 720, spectrometer 710 is auto-focused and can image the sample.

System 700 and spectrometer 710 are used to image a dispensed pharmaceutical 750 in a prescription vial 760, for example. System 700 and spectrometer 710 can image dispensed pharmaceutical 750 through the open top of prescription vial 760, for example.

In various embodiments, electro-mechanical front lens set 730 moves light source 770 along with electro-mechanical front lens set 730 in order to align light transmitted to and received from dispensed pharmaceutical 750. Light source 770 can include, but is not limited to, a laser. Light source 770 is attached to adjustable lens 732 of electro-mechanical front lens set 730, for example. Light source 770, therefore, moves with adjustable lens 732 along guide rails 734.

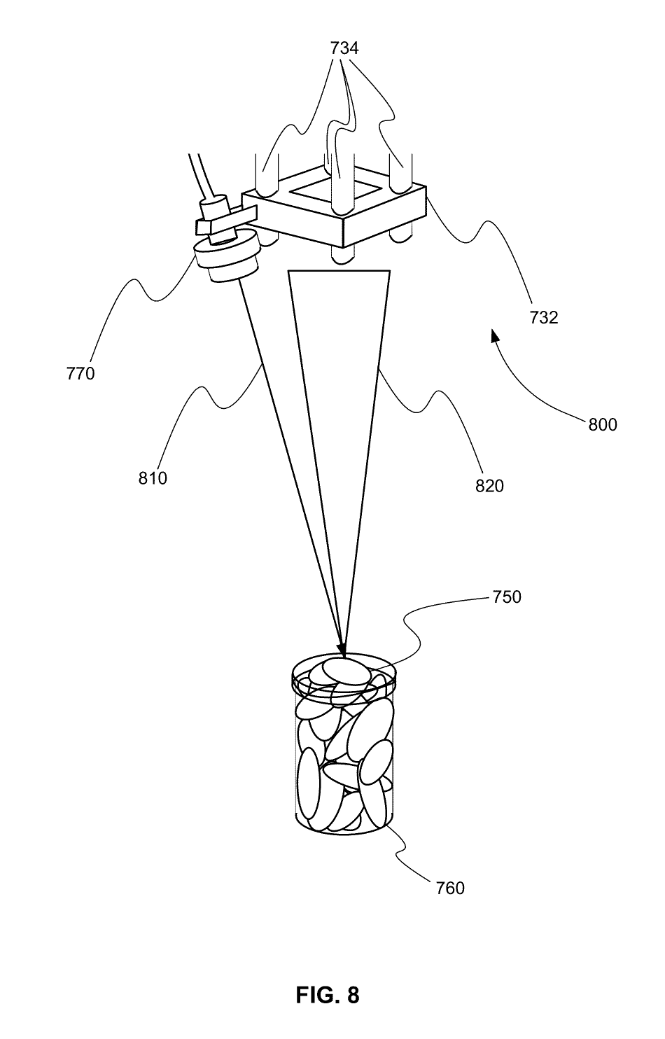

FIG. 8 is schematic diagram of a close-up view of a sample end 800 of a system for auto-focusing a spectrometer, in accordance with various embodiments. The system for auto-focusing the spectrometer includes adjustable lens 732 that moves along guide rails 734. Light source 770 is attached to adjustable lens 732 and moves with adjustable lens 732 along guide rails 734. Light source 770 transmits light along transmitted light path 810 to dispensed pharmaceutical 750 through the open top of prescription vial 760. Adjustable lens 732 receives light along received light path 820 from dispensed pharmaceutical 750.

Because of the geometry of transmitted light path 810 and received light path 820, there is only one point where the light transmitted from light source 770 is centered on the image of the zero order detector of the system for auto-focusing a spectrometer. This is the auto-focus position. Adjustable lens 732 is moved back and forth until the auto-focus position is found. The auto-focus position is found by measuring the light intensity at the zero order detector. The zero order detector receives the maximum light intensity at the auto-focus position.

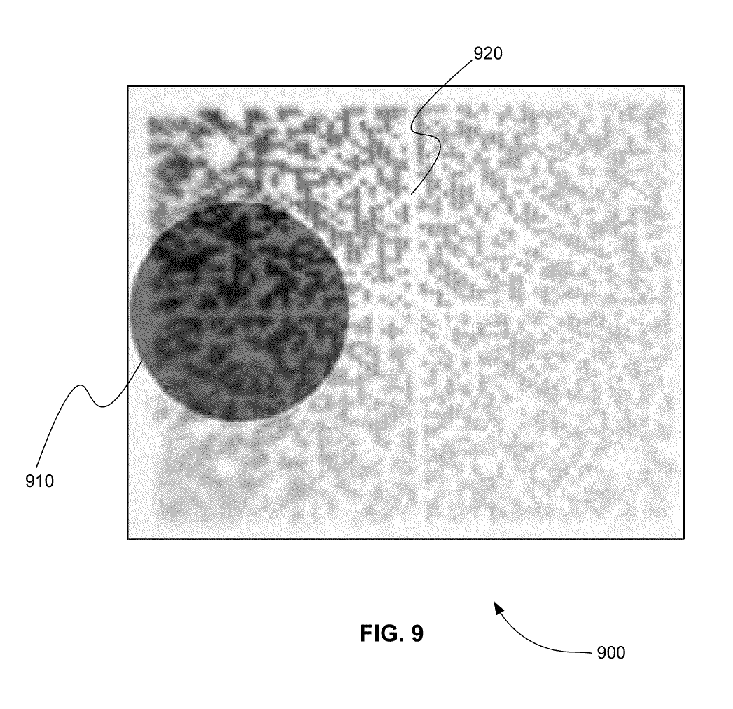

FIG. 9 is an exemplary image 900 from a zero order detector of a system for auto-focusing a spectrometer that shows that a sample is too far away from auto-focusing system, in accordance with various embodiments. Light source spot 910 is shown on the left hand side of mask 920.

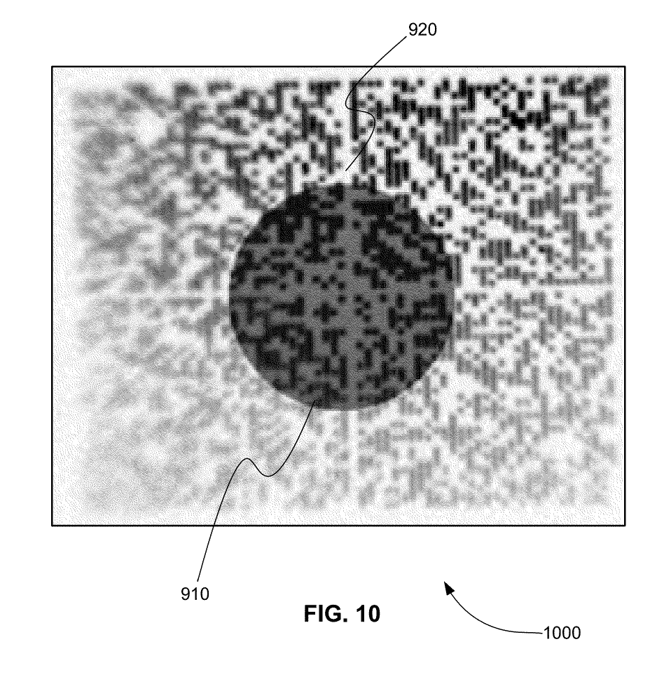

FIG. 10 is an exemplary image 1000 from a zero order detector of a system for auto-focusing a spectrometer that shows that a sample is at the auto-focus position, in accordance with various embodiments. Light source spot 910 is shown near the center of mask 920.

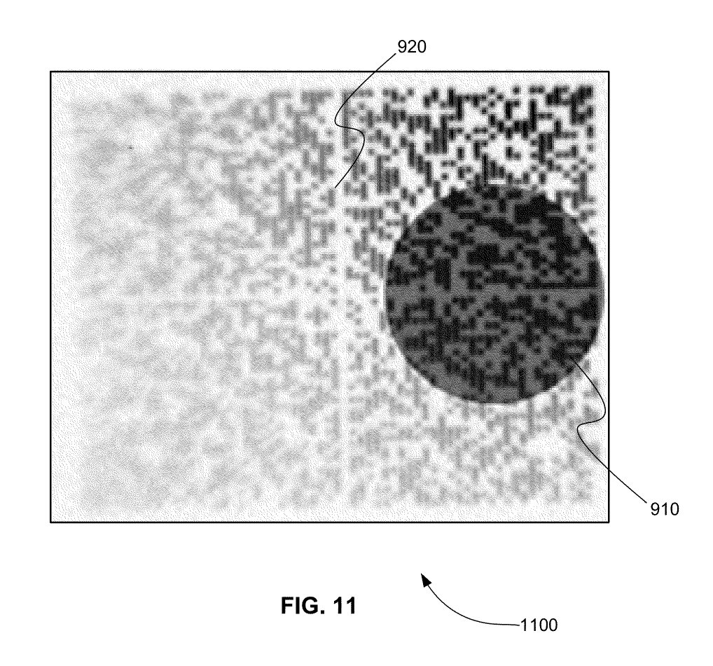

FIG. 11 is an exemplary image 1100 from a zero order detector of a system for auto-focusing a spectrometer that shows that a sample is too close to the auto-focusing system, in accordance with various embodiments. Light source spot 910 is shown on the right hand side of mask 920.

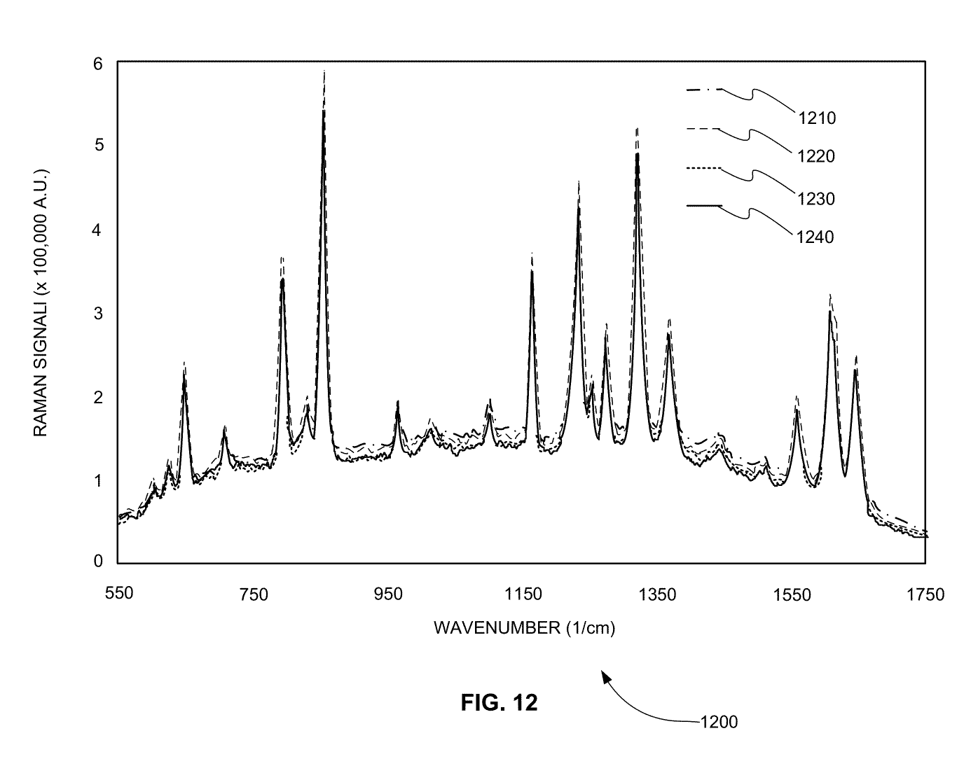

FIG. 12 is an exemplary graph 1200 showing Raman signals for a dispensed pharmaceutical located at different distances and measured using a spectrometer that includes a system for auto-focusing the spectrometer, in accordance with various embodiments. Raman signal 1210 was measured for the dispensed pharmaceutical at 0 mm. Raman signal 1220 was measured for the dispensed pharmaceutical at 30 mm. Raman signal 1230 was measured for the dispensed pharmaceutical at 70 mm. Raman signal 1240 was measured for the dispensed pharmaceutical at 80 mm. The correlation of Raman signals 1210, 1220, 1230, and 1240 shows that a system for auto-focusing a spectrometer allows the spectrometer to measure the same sample accurately at different distances.

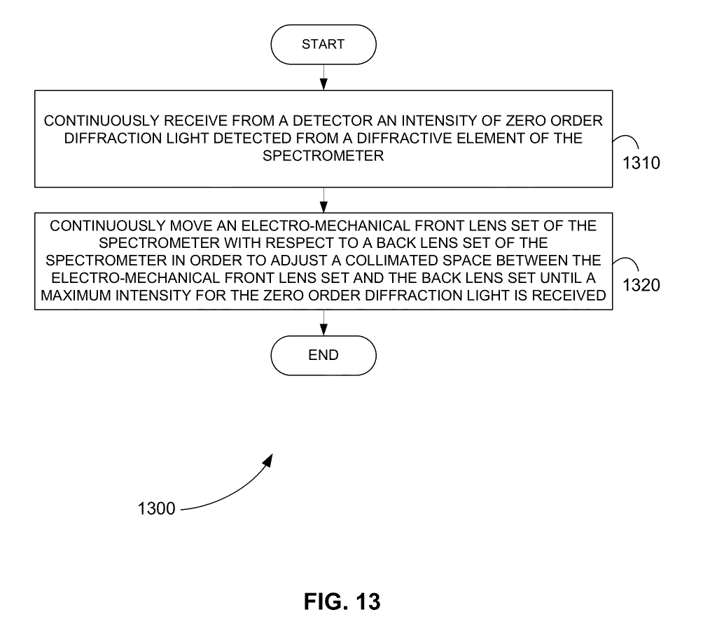

FIG. 13 is an exemplary flowchart showing a method 1300 for auto-focusing a spectrometer, in accordance with various embodiments.

In step 1310 of method 1300, the intensity of zero order diffraction light measured by a detector from a diffractive element of a spectrometer is continuously received.

In step 1320, an electro-mechanical front lens set of the spectrometer is continuously moved with respect to a back lens set of the spectrometer in order to adjust a collimated space between the electro-mechanical front lens set and the back lens set until a maximum intensity for the zero order diffraction light is measured.

In various embodiments, a computer program product includes a tangible computer-readable storage medium whose contents include a program with instructions being executed on a processor so as to perform a method for auto-focusing a spectrometer. This method is performed by a system that includes one or more distinct software modules.

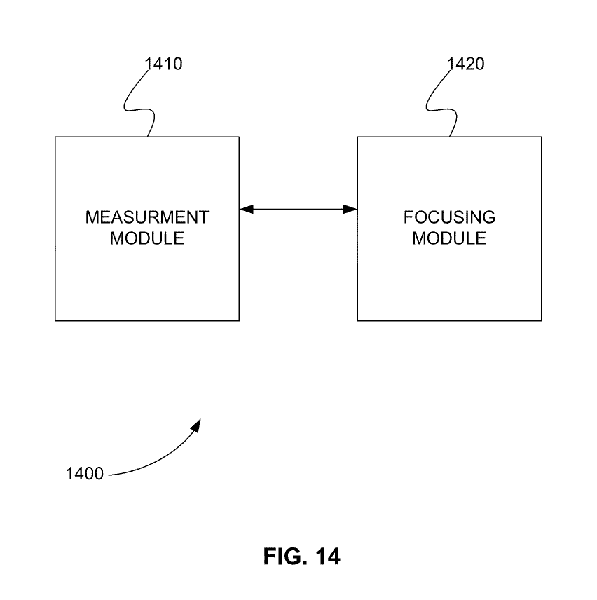

FIG. 14 is a schematic diagram of a system 1400 that includes one or more distinct software modules that perform a method for auto-focusing a spectrometer, in accordance with various embodiments. System 1400 includes measurement module 1410 and focusing module 1420.

Measurement module 1410 continuously receives from a detector an intensity of zero order diffraction light measured from a diffractive element of a spectrometer.

Focusing module 1420 continuously moves an electro-mechanical front lens set of the spectrometer with respect to a back lens set of the spectrometer in order to adjust a collimated space between the electro-mechanical front lens set and the back lens set. Focusing module 1420 continuously moves the electro-mechanical front lens set until a maximum intensity for the zero order diffraction light is measured.

### Systems and Methods for Optical Path Increased Light Collection

The auto focusing system shown in FIG. 7 is one embodiment of one solution, i.e., optimal light collection, for the general problem of light collection in a spectrometer. Increased light collection is especially important for high throughput systems. In a high throughput system, the availability to a sample is limited. As a result, it is desirable to collect the most amount of light that is possible during the time a sample is available.

In various embodiments and as described above, light collection is increased by finding the optimal light collection for a spectrometer. The optimal light collection for the spectrometer is found by detecting and measuring the zero order diffraction light from a diffractive element of the spectrometer and automatically adjusting a parameter of the spectrometer until the zero order diffraction light reaches a maximum.

The zero order diffraction light from a diffraction element is the light that is not diffracted by the diffraction element. Higher order diffraction light is the light that is diffracted at increasing angles. For example, the first order diffraction light is the light diffracted at the first angle of a diffraction grating.

The parameter of the spectrometer that is adjusted is the optical path between the sample and the spectrometer. The distance between the sample and the spectrometer is adjusted by moving the objective lens of the spectrometer with respect to the sample. In various alternative embodiments (not shown), the sample can be moved with respect to the objective lens of the spectrometer.

Zero order diffraction light has not been used before to find the optimal light collection for a spectrometer, either because it was not readily available or because it was not necessary to automatically increase the number of photons reaching the spectrometer. For example, in spectrometers that use reflective gratings, the zero order diffraction light is reflected in the same direction as the incident light. As a result, it is difficult to detect the zero order diffraction light.

In addition, in most spectrometry applications the optical path between the sample and the spectrometer can be controlled manually. The sample is simply placed at the correct optical path from the spectrometer.

Even in applications where this optical path cannot be controlled, such as stand-off spectroscopy, there are other ways to increase the number of photons reaching the spectrometer. For example, the intensity of the light source can be increased, or the exposure time can be increased.

As described above, however, high throughput spectroscopy demands more precise systems and methods for increasing light collection in a spectrometer. Such systems and methods are required to make this determination automatically and under strict time limits.

In various embodiments, using zero order diffraction light to increase light collection for a spectrometer allows the increase to be made automatically and under strict time limits. The zero order diffraction light can be detected and measured using a fast point detector, such as a diode, for example.

In contrast, a detector of a conventional spectrometer that detects higher order diffraction light may be good at measuring spectra, but it may not be as good at measuring light intensity or power. Or, it may not be able to measure light intensity quickly. For example, the charged coupled device (CCD) of many conventional spectrometers have slow read times in order to page out a full frame before sending any information.

In addition, some conventional spectrometers perform a protocol before sending any information. For example, a spectrometer may perform a dark subtract while gathering data. In order to use such a spectrometer for increasing light collection, at least one additional mode of operation would have to be added to the spectrometer's protocol, increasing the overall data collection time.

In various embodiments, finding the optimal light collection of a spectrometer is performed in parallel with spectral measurement. For example, the zero order diffraction light is detected and measured using a detector separate from a detector of the spectrometer that is used for detecting a spectrum. Zero order detector 720 is shown in FIG. 7 as a separate detector. Spectrometer 710 of FIG. 7 has a 90° geometry. In a 90° geometry the zero order diffraction light is readily available.

As described above, finding the optimal light collection for a spectrometer is one solution to the general problem of increasing light collection in a spectrometer. Additional solutions include increasing the intensity of a light source or increasing the exposure time of the spectrometer. Increasing the intensity of the light source or increasing the exposure time of the spectrometer increases the overall number of photons available rather than optimizing the number of photons that reach the spectrometer. The intensity of the light source and the exposure time of the spectrometer are also spectrometer parameters. In conventional spectrometers these parameters are typically adjusted manually.

In various embodiments, light collection in a spectrometer is increased by automatically adjusting intensity of the light source or the exposure time of the spectrometer. The intensity of the light source or the exposure time of the spectrometer is adjusted in response to the intensity of the zero order diffraction light from a detector element of the spectrometer. The intensity of the light source or the exposure time of the spectrometer is increased until a maximum zero order diffraction light intensity is measured.

FIG. 7 also shows a system 700 for increasing light collection in a spectrometer, in accordance with various embodiments. Detector 720 detects zero order diffraction light from diffractive element 714 of spectrometer 710. Diffractive element 714 can be reflective or transmissive. Spectrometer 710 can be a Raman spectrometer, for example. Spectrometer 710 can include an aperture mask. Detector 720 measures an intensity of the zero order diffraction light. In various embodiments, detector 720 that is separate from detector 718 of spectrometer 710 that is used for detecting a spectrum. Alternatively, detector 720 and detector 718 can be the same detector.

Processor 740 is in communication with detector 720 and spectrometer 710. Processor 740 continuously receives the intensity measurement from detector 720. Processor 740 automatically adjusts a parameter of spectrometer 710 until a maximum intensity measurement is received from detector 720.

In various embodiments, the parameter of spectrometer 710 is an optical path between aperture 712 of spectrometer 710 and sample 750.

In various embodiments, processor 740 adjusts an optical path between aperture 712 of spectrometer 720 and sample 750 by moving an objective lens of spectrometer 710 with respect to sample 750. The objective lens is, for example, electro-mechanical front lens set 730 that moves with respect to a back lens set 716. Electro-mechanical front lens set 730 moves with respect to back lens set 716 in order to adjust the collimated space between electro-mechanical front lens set 730 and back lens set 716. Electro-mechanical front lens set 730 is, for example, the front end lens relay.

In various embodiments, electro-mechanical front lens set 730 moves light source 770 along with electro-mechanical front lens set 730 in order to align light transmitted to and received from sample 750.

In various embodiments, processor 740 adjusts the optical path between aperture 712 of spectrometer 720 and sample 750 by moving sample 750 or sample container 760 with respect to spectrometer 720.

In various embodiments, the parameter of spectrometer 710 is an exposure time of the spectrometer or an intensity of light source 770.

In various embodiments, spectrometer 710 images dispensed pharmaceutical 750. Spectrometer 719 images dispensed pharmaceutical 750 through an open top of prescription vial 760, for example.

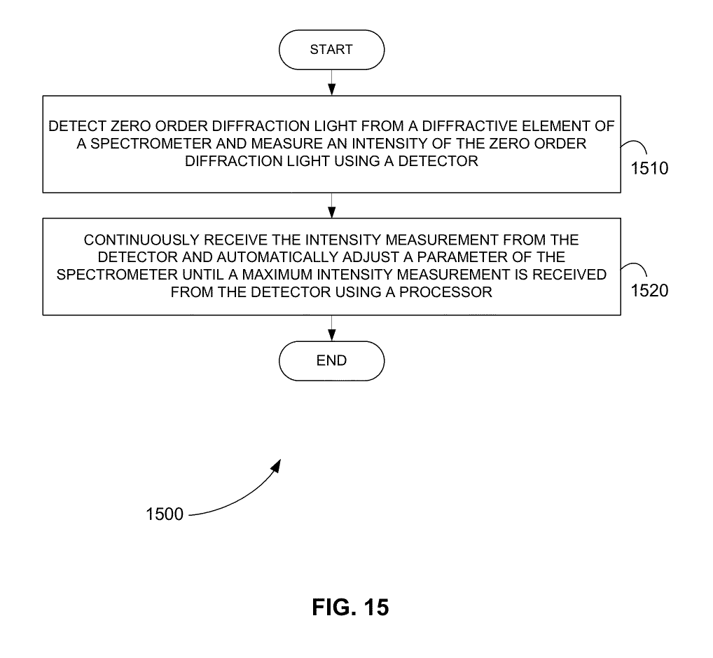

FIG. 15 is an exemplary flowchart showing a method 1500 for increasing light collection in a spectrometer, in accordance with various embodiments.

In step 1510 of method 1500, zero order diffraction light from a diffractive element of a spectrometer is detected and an intensity of the zero order diffraction light is measured using a detector;

In step 1520, the intensity measurement from the detector is continuously received and a parameter of the spectrometer is automatically adjusted until a maximum intensity measurement is received from the detector using a processor.

In various embodiments, a computer program product includes a tangible computer-readable storage medium whose contents include a program with instructions being executed on a processor so as to perform a method for increasing light collection in a spectrometer. This method is performed by a system that includes one or more distinct software modules.

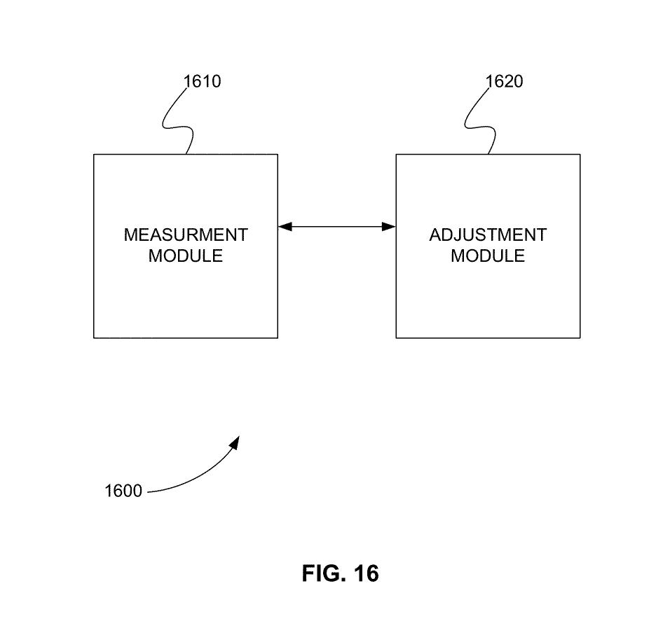

FIG. 16 is a schematic diagram of a system 1600 that includes one or more distinct software modules that perform a method for increasing light collection in a spectrometer, in accordance with various embodiments. System 1600 includes measurement module 1610 and adjustment module 1620.

Measurement module 1610 continuously receives an intensity of zero order diffraction light from a diffractive element of a spectrometer detected and measured by a detector.

Adjustment module 1620 automatically adjusts a parameter of the spectrometer until a maximum intensity measurement is received from the detector.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for increasing light collection in a spectrometer, comprising:
a detector that detects zero order diffraction light from a diffractive element of a spectrometer and measures an intensity of the zero order diffraction light; and
a processor in communication with the detector and the spectrometer that continuously receives the intensity measurement from the detector and automatically adjusts a parameter of the spectrometer until a maximum intensity measurement is received from the detector.

2. The system of claim 1, wherein the parameter of the spectrometer comprises an optical path between an aperture of the spectrometer and a sample.

3. The system of claim 2, wherein the processor adjusts the optical path between an aperture of the spectrometer and the sample by moving an objective lens of the spectrometer with respect to the sample.

4. The system of claim 2, wherein the processor adjusts the optical path between an aperture of the spectrometer and the sample by moving the sample with respect to the spectrometer.

5. The system of claim 1, wherein the parameter of the spectrometer comprises an exposure time of the spectrometer.

6. The system of claim 1, wherein the parameter of the spectrometer comprises an intensity of a light source for the spectrometer.

7. The system of claim 3, wherein the objective lens comprises an electro-mechanical front lens set of the spectrometer that moves with respect to a back lens set of the spectrometer.

8. The system of claim 7, wherein the electro-mechanical front lens set of the spectrometer moves with respect to the back lens set of the spectrometer in order to adjust the collimated space between the electro-mechanical front lens set and the back lens set.

9. The system of claim 7, wherein the electro-mechanical front lens set comprises the front end lens relay.

10. The system of claim 7, wherein the electro-mechanical front lens set moves a light source along with the electro-mechanical front lens set in order to align light transmitted to and received from the sample.

11. The system of claim 1, wherein the spectrometer comprises a Raman spectrometer.

12. The system of claim 1, wherein the spectrometer comprises an aperture mask spectrometer.

13. The system of claim 1, wherein the spectrometer images a dispensed pharmaceutical.

14. The system of claim 13, wherein the spectrometer images the dispensed pharmaceutical through an open top of a prescription vial.

15. The system of claim 1, wherein the detector comprises a detector of the spectrometer that is used for detecting a spectrum.

16. The system of claim 1, wherein the detector comprises a detector that is separate from a detector of the spectrometer that is used for detecting a spectrum.

17. The system of claim 1, wherein the diffractive element is reflective.

18. The system of claim 1, wherein the diffractive element is transmissive.

19. A method for increasing light collection in a spectrometer, comprising:
detecting zero order diffraction light from a diffractive element of a spectrometer and measuring an intensity of the zero order diffraction light using a detector; and
continuously receiving the intensity measurement from the detector and automatically adjusting a parameter of the spectrometer until a maximum intensity measurement is received from the detector using a processor.

20. A computer program product, comprising a tangible computer-readable storage medium whose contents include a program with instructions being executed on a processor so as to perform a method for increasing light collection in a spectrometer, the method comprising:
providing a system, wherein the system comprises one or more distinct software modules, and wherein the distinct software modules comprise a measurement module and an adjustment module;
continuously receiving an intensity of zero order diffraction light from a diffractive element of a spectrometer detected and measured by a detector using the measurement module; and
automatically adjusting a parameter of the spectrometer until a maximum intensity measurement is received from the detector using the adjustment module.
